(19) United States
(12) Patent Application Publication
(10) Pub. No.: US 2021/0299611 A1
(43) Pub. Date: Sep. 30, 2021

(54) System and Method for Recovering Isotopologues from a Gas Stream

(71) Applicant: Anthony Busigin, Ocala, FL (US)

(72) Inventor: Anthony Busigin, Ocala, FL (US)

(21) Appl. No.: 16/829,306

(22) Filed: Mar. 25, 2020

(51) Int. Cl. B01D 59/08; B01D 59/32

(52) U.S. Cl. CPC B01D 59/08; C01B 4/00; B01D 59/32

(57) ABSTRACT

A method for recovering isotopologues from a gas stream is provided with a wet scrubber column, which includes a liquid inlet, a liquid outlet, a gas inlet, a gas outlet, and a plurality of bubble cap trays. An initial gas stream is enriched with isotopologues, while an initial aqueous liquid is depleted of isotopologues. The initial gas stream is countercurrently contacting the initial aqueous solution through the bubble cap trays as the initial gas stream traverses from the gas inlet to the gas outlet and as the initial aqueous liquid traverses from the liquid inlet to the liquid outlet. A processed gas stream is then captured from the gas outlet and is depleted of isotopologues. Simultaneously, a processed aqueous liquid is captured from the liquid outlet and is enriched with isotopologues.

### FIELD OF THE INVENTION

The present invention generally relates to water processing. More specifically, the present invention is a method and system for scrubbing deuterium and tritium isotopes from a gas stream by countercurrent exchange or absorption into liquid water or an aqueous liquid solution.

### BACKGROUND OF THE INVENTION

Tritium (symbol: T or ³H) is a radioactive isotope of hydrogen of atomic mass 3.016 and half-life of 12.3 years. Tritium capture is generally important to minimize occupational exposure and to reduce environmental emissions.

Some problems with the current art of packed and plate wet scrubber columns for deuterium/tritium capture include the following:
(a) at very low liquid loadings, typical of deuterium/tritium wet scrubber columns, complete wetting of packing or plates, or the liquid perimeter in case of a very small column with static mixers, is difficult to achieve, particularly if the wetted surface loses its hydrophilic character;
(b) turn down to zero is not possible, otherwise wetting and uniform liquid distribution is lost, and it may not be fully restored upon resumption of operation;
(c) in a standby system, such as a safety system, maintenance of water flow to maintain wetting increases the quantity of water that must be managed downstream prior to discharge;
(d) if water flow is stopped or greatly reduced, deuterium/tritiated water vapor freely migrates upward through packing or plates, spreading contamination that can result in unwanted emissions upon restart;
(e) oxidized phosphor bronze packing used in wet scrubber columns is subject to corrosion in air due to atmospheric carbon dioxide water acidification, and due to other acid gases, causing it to lose its hydrophilic copper oxide layer and its wettability; and
(f) after shutdown and dry out, trace organic contaminants readily absorb on hydrophilic packing surfaces, often making the packing to be hydrophobic at the next startup, which is an undesirable technology characteristic for a standby safety system.

The present invention is used in scrubbing of deuterium and/or tritium isotopes from a gas stream containing water vapor, acid vapor, or other chemical form(s) containing deuterium and/or tritium that can be exchanged into or absorbed into liquid water or an aqueous liquid solution. As disclosed herein, the term gas stream refers to a stream comprised mostly of non-condensable gas. In addition, as disclosed herein, the term “isotopologues” refers to molecular entities that differ only in their isotopic composition (IUPAC Compendium of Chemical Technology, Electronic Version). For example, water isotopologues may contain one or two deuterium or tritium atoms in place of hydrogen, or an ¹⁷O or ¹⁸O atom in place of ¹⁶O. The method herein described is therefore applicable to the recovery of all isotopologues of water, examples of which are HTO, T₂O, HDO, D₂O, as well as water containing ¹⁷O or ¹⁸O. It is also applicable to other isotopologues that can be absorbed in water, examples of which are HCl, DCl, TCl, HTSO₄, DTSO₄, etc.

### SUMMARY OF THE INVENTION

The present invention is used in recovering hydrogen isotope(s) of interest from a stream through the following aspects:
(a) an improved wet scrubber column design bringing a gas/vapor stream into countercurrent contact with an aqueous liquid stream substantially depleted in the isotope(s) of interest;
(b) withdrawing the liquid enriched with said isotope(s) of interest; and
(c) employing bubble cap trays with a water seal between trays to facilitate exchange/absorption from rising gas/vapor to liquid flowing down the column by gravity from tray to tray.

An objective of the present invention is to provide a continuous, simple, inherently safe, and more reliable process for the detritiation of gas/vapor streams.

Another objective of the present invention is to avoid the loss of packing wettability problems associated with packed and plate columns.

Another objective of the present invention is to allow turn down to zero as compared to packed and plate columns that require continuous water flow to irrigate wetted surfaces to prevent dry out. For the present invention, when flows are turned down to zero, water sits in trays, with water seals fully intact, and the column remains in a ready state for resumption of flows.

### BRIEF DESCRIPTION OF THE DRAWINGS

FIG. 1 is a schematic view illustrating the system of the present invention with a cooling jacket.

FIG. 2 is a schematic view illustrating the system of the present invention with a condenser.

FIG. 3 is a flowchart illustrating an overall process for the method of the present invention.

FIG. 4 is a flowchart illustrating a subprocess for continuously flowing aqueous liquid through the wet scrubber column.

FIG. 5 is a flowchart illustrating a subprocess for implementing the downcomers for the wet scrubber column.

FIG. 6 is a flowchart illustrating a subprocess for implementing a static liquid flowrate through the wet scrubber column.

FIG. 7 is a flowchart illustrating a subprocess for implementing a dynamic liquid flowrate through the wet scrubber column.

FIG. 8 is a flowchart illustrating a subprocess for liquid-sealing bubble cap trays for the wet scrubber column.

FIG. 9 is a flowchart illustrating a subprocess for liquid-sealing a sump for the wet scrubber column.

FIG. 10 is a flowchart illustrating a subprocess for cooling a gas stream with the cooling jacket.

FIG. 11 is a flowchart illustrating a subprocess for cooling a gas stream with the condenser.

FIG. 12 is a flowchart illustrating a subprocess for transitioning the wet scrubber column from a shutdown state to a standby state.

FIG. 13 is a flowchart illustrating a subprocess for maintaining the standby state for the wet scrubber column in between iterations of the overall process;

FIG. 14 is a flowchart illustrating a subprocess for initializing the shutdown state for the wet scrubber column.

FIG. 15 is a flowchart illustrating a subprocess for draining the bubble cap trays prior to the shutdown state for the wet scrubber column.

### DETAILED DESCRIPTION OF THE INVENTION

All illustrations of the drawings are for the purpose of describing selected versions of the present invention and are not intended to limit the scope of the present invention.

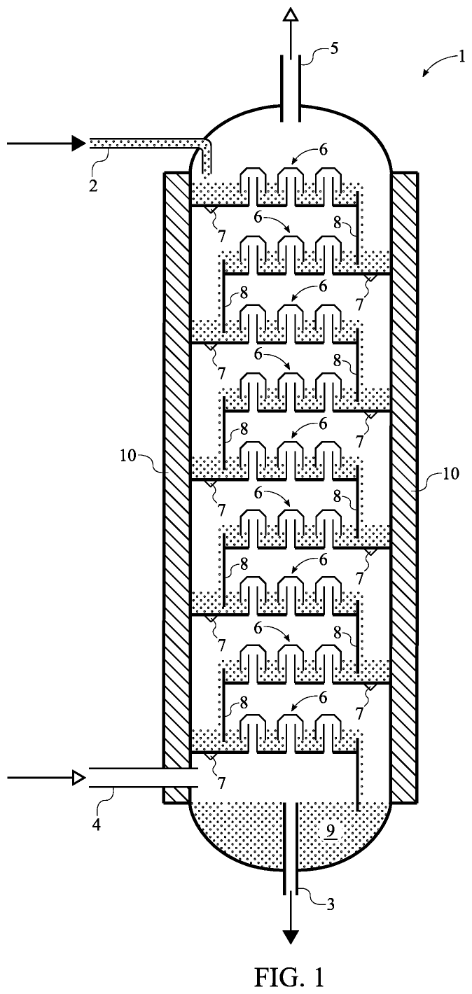

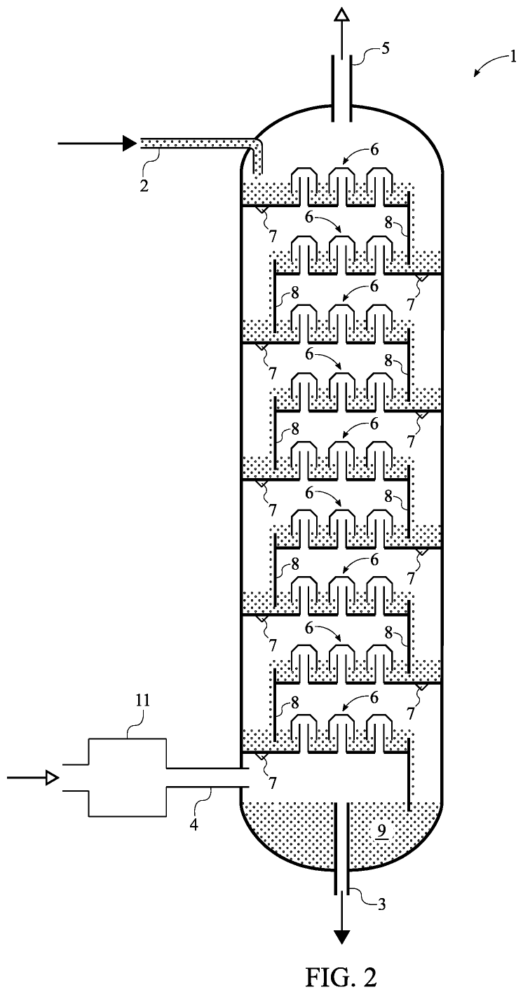

The present invention is a system and method of recovering isotopologues from a gas stream in order to reduce its concentration of deuterium and/or tritium. As can be seen in FIGS. 1 and 2, the system of the present invention is provided with a wet scrubber column 1 (Step A), which is a vertically-oriented enclosure that allow for the exchange of isotopologues between a gas stream and an aqueous liquid. A transversal cross section of the wet scrubber column 1 is preferably circular. The wet scrubber column 1 includes a liquid inlet 2, a liquid outlet 3, a gas inlet 4, a gas outlet 5, and a plurality of bubble cap trays 6. The liquid inlet 2 allows for aqueous liquid to enter the wet scrubber column 1, while the liquid outlet 3 allows for the aqueous liquid to exit the wet scrubber column 1. Similarly, the gas inlet 4 allows for a gas stream to enter the wet scrubber column 1, while the gas outlet 5 allows for the gas stream to exit the wet scrubber column 1.

Moreover, the plurality of bubble cap trays 6 is used to force interfacial contact between a gas stream and an aqueous liquid that are countercurrently moving through the wet scrubber column 1. Thus, the liquid inlet 2 and the liquid outlet 3 need to be in fluid communication with each other through the plurality of bubble cap trays 6 in order to facilitate the interfacial contact between the gas stream and the aqueous liquid. Likewise, the gas inlet 4 and the gas outlet 5 need to be in fluid communication with each other through the plurality of bubble cap trays 6 in order to facilitate the interfacial contact between the gas stream and the aqueous liquid. In addition, the system of the present invention is further provided with a gas stream (Step B) that flows through the wet scrubber column 1. Moreover, an initial portion of the gas stream is enriched with isotopologues (e.g. deuterium and/or tritium). The initial portion of the gas stream may be made of water vapor, acid vapor, or another kind of chemical vapor that has a higher concentration of deuterium and/or tritium. The system of the present invention is further provided with an initial quantity of aqueous liquid (Step C), which is depleted of isotopologues. The initial quantity of aqueous liquid may be made of liquid water or some other kind of aqueous solution that has a lower concentration of deuterium and/or tritium.

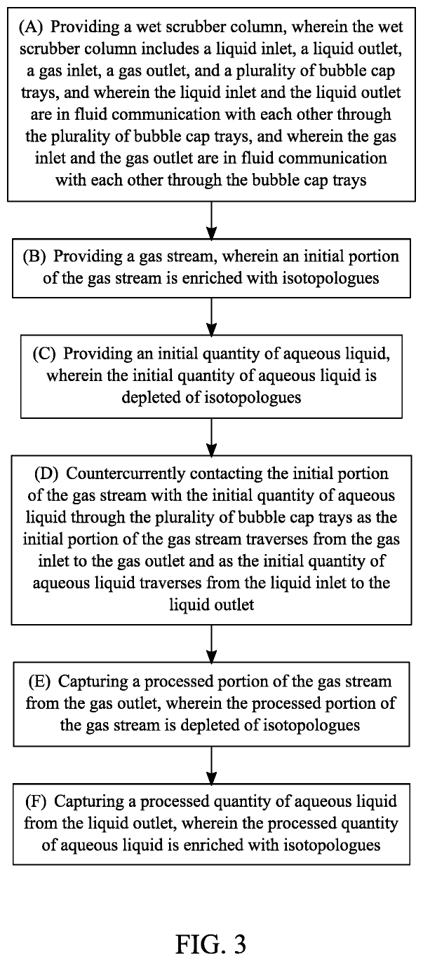

As can be seen in FIG. 3, the overall process followed by the method of the present invention allows to effectively and efficiently exchange isotopologues from a gas stream to an aqueous liquid and thereby cleaning the gas stream of isotopologues with the aqueous liquid. The overall process begins by countercurrently contacting the initial portion of the gas stream with the initial quantity of aqueous liquid through the plurality of bubble cap trays 6 as the initial portion of the gas stream traverses from the gas inlet 4 to the gas outlet 5 and as the initial quantity of aqueous liquid traverses from the liquid inlet 2 to the liquid outlet 3 (Step D). This allows deuterium and/or tritium to be transferred from the initial portion of the gas stream to the initial quantity of aqueous liquid through a phase-isotope exchange and absorption process as the initial portion of the gas stream is aerated through the initial quantity of aqueous liquid by the plurality of bubble cap trays 6. The overall process continues by capturing a processed portion of the gas stream from the gas outlet 5 (Step E), wherein the processed portion of the gas stream is depleted of isotopologues. The processed portion of the gas stream is the end result of the initial portion of the gas stream after being passed through the wet scrubber column 1. The overall process concludes by capturing a processed quantity of aqueous liquid from the liquid outlet 3 (Step F), wherein the processed quantity of aqueous liquid is enriched with isotopologues. Similarly, the processed quantity of aqueous liquid is the end result of the initial quantity of aqueous liquid after being passed through the wet scrubber column 1.

One specification that may be made to the overall process is for the gas stream to be made of an incondensable gas. This specification prevents any portion of the gas stream to phase change into liquid and consequently prevents a disruption of the phase-isotope exchange and absorption process during Step D.

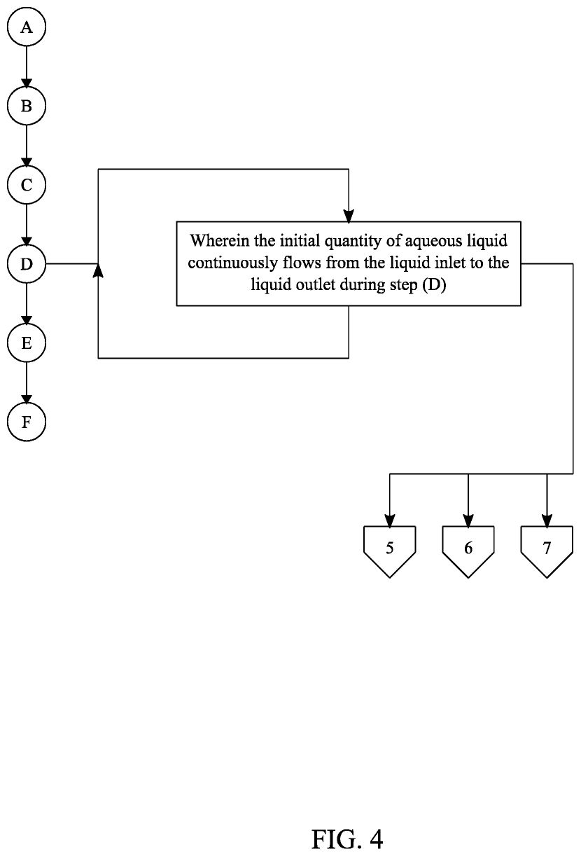

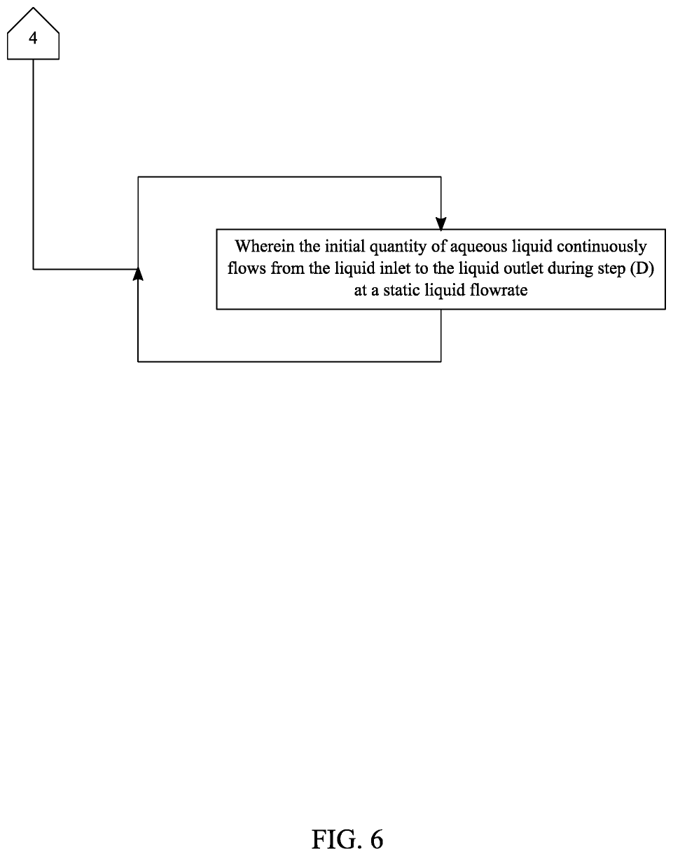

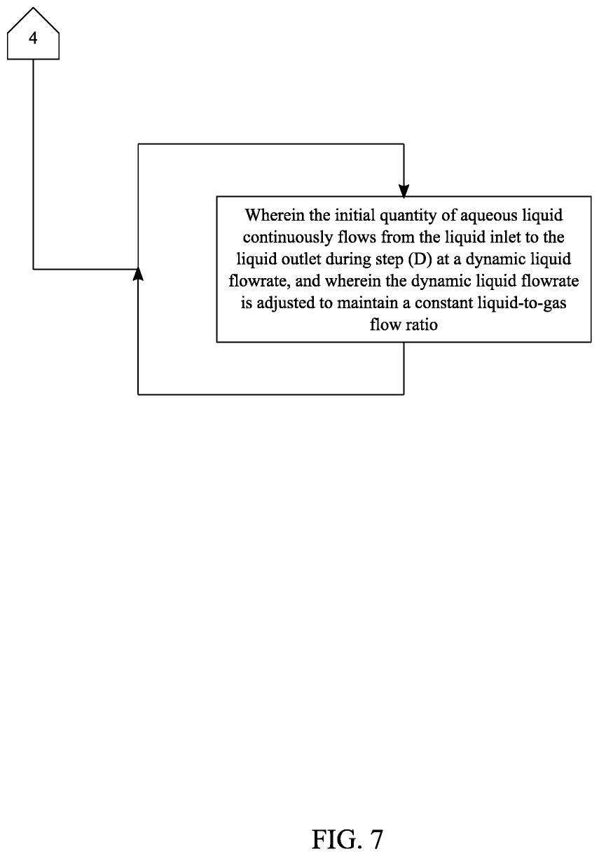

Another specification that may be made to the overall process is for the initial quantity of aqueous liquid to continuously flow from the liquid inlet 2 to the liquid outlet 3 during Step D, which is shown in FIG. 4. This specification provides a sufficient liquid flow in order to effectively and efficiently exchange isotopologues from a gas stream to an aqueous liquid within the wet scrubber column 1. Moreover, a higher liquid-to-gas flow ratio results in a higher rate of exchanging isotopologues from a gas stream to an aqueous liquid. A liquid-to-gas flow ratio is the amount of liquid flow through the wet scrubber column 1 in relation to the amount of gas/vapor flow through the wet scrubber column 1. Thus, the initial quantity of aqueous liquid can continuously flow from the liquid inlet 2 to the liquid outlet 3 during Step D at a static liquid flowrate, which is shown in FIG. 6. The static liquid flowrate is set to be a relatively-higher constant value so that the wet scrubber column 1 is always able to maintain a relatively-high rate of exchanging isotopologues from a gas stream to an aqueous liquid. Alternatively, the initial quantity of aqueous liquid can continuously flow from the liquid inlet 2 to the liquid outlet 3 during Step D at a dynamic liquid flowrate, which is shown in FIG. 7. The dynamic liquid flowrate is adjusted to maintain a constant liquid-to-gas flow ratio. The constant liquid-to-gas flow ratio is set to be a relatively-moderate constant value because the dynamic liquid flowrate is continuously manipulated to maintain the constant liquid-to-gas flow ratio.

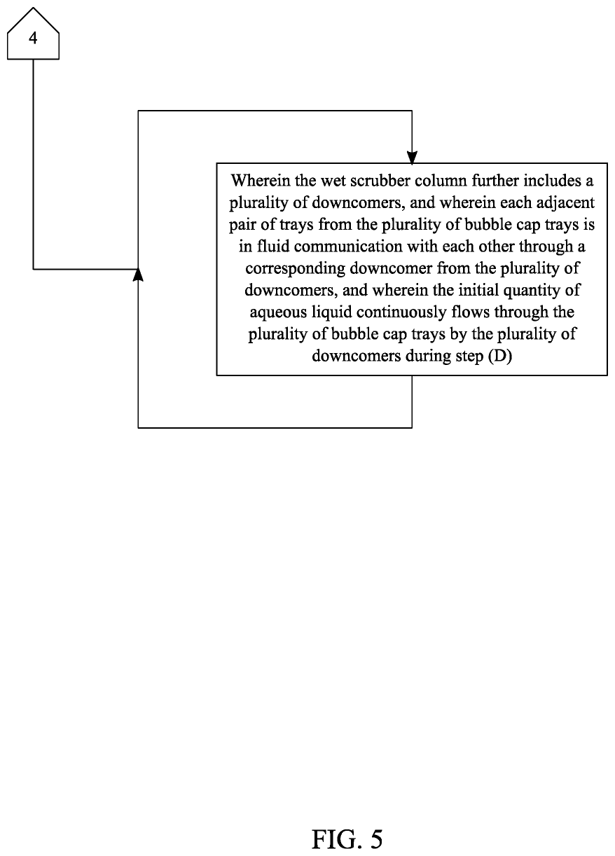

In order to implement the aforementioned specification, the wet scrubber column 1 may further include a plurality of downcomers 8, which is shown in in FIGS. 1, 2, and 5. The plurality of downcomers 8 is used to gravitationally transfer liquid from a higher elevation point to a lower elevation point. Thus, each adjacent pair of trays from the plurality of bubble cap trays 6 (i.e. one tray is at a higher elevation point, and another tray is at a lower elevation point) is in fluid communication with each other through a corresponding downcomer from the plurality of downcomers 8. Consequently, the initial quantity of aqueous liquid is able to continuously flow through the plurality of bubble cap trays 6 by the plurality of downcomers 8 during Step D. Each of the plurality of downcomers 8 is preferably an overflow downcomer but can alternatively be a pipe downcomer, a hanging downcomer, or any other kind of downcomer.

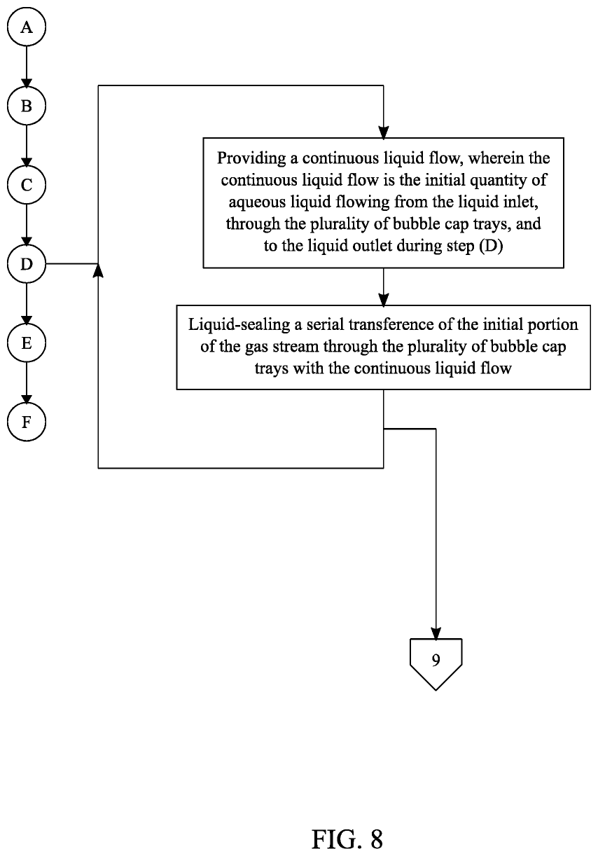

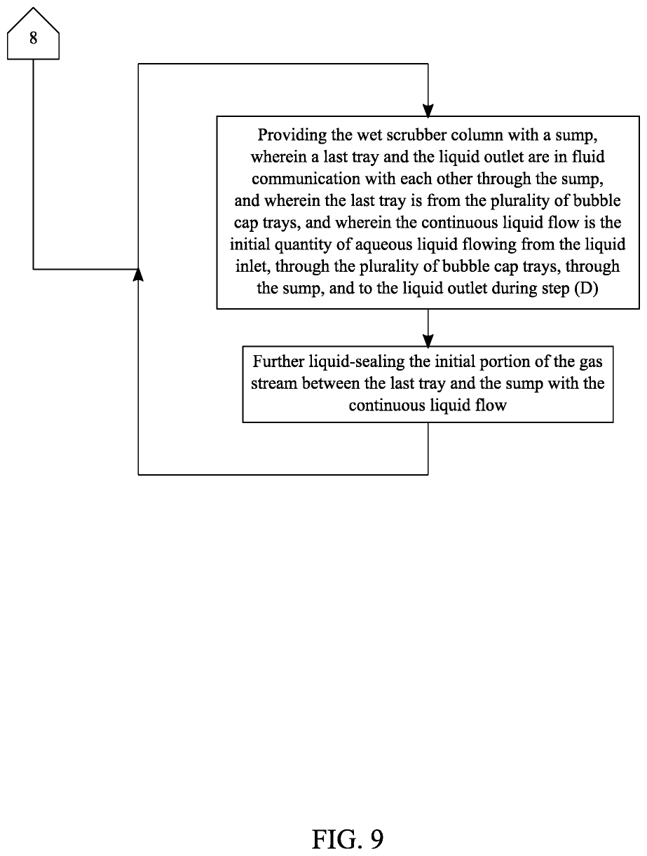

As can be seen in FIG. 8, another specification that may be made to the overall process is the initial portion of gas stream to continuously flow from the gas inlet 4 to the gas outlet 5 during Step D. In order to implement this specification, a continuous liquid flow needs to be maintained through the wet scrubber column 1, wherein the continuous liquid flow is defined as the initial quantity of aqueous liquid flowing from the liquid inlet 2, through the plurality of bubble cap trays 6, and to the liquid outlet 3 during Step D. Moreover, the continuous liquid flow is maintained by the corresponding downcomer for each adjacent pair of trays, which allows for liquid-sealing a serial transference of the initial portion of the gas stream through the plurality of bubble cap trays 6. The serial transference of the initial portion of the gas stream refers to the gas/vapor flow from the space immediately above one tray at a lower elevation point to the space immediately above another tray at a higher elevation point. In addition, the continuous liquid flow needs to extend between the last tray from the plurality of bubble cap trays 6 to the liquid outlet 3 in order to complete the necessary liquid-sealing for the initial portion of gas stream to continuously flow from the gas inlet 4 to the gas outlet 5 during Step D. As can be seen in FIGS. 1, 2, and 9, the wet scrubber column 1 may be provided with a sump 9 that is used to retain the initial portion of aqueous liquid before exiting through the liquid outlet 3. The last tray and the liquid outlet 3 are in fluid communication with each other through the sump 9 so that the continuous liquid flow is further defined as the initial quantity of aqueous liquid flowing from the liquid inlet 2, through the plurality of bubble cap trays 6, through the sump 9, and to the liquid outlet 3 during Step D. Consequently, the sump 9 allows for further liquid-sealing the initial portion of gas stream between the last tray and the sump 9 with the continuous liquid flow, which allows the initial portion of gas stream to flow from the gas inlet 4, through the space immediately above the sump 9 and the liquid outlet 3, through the last tray, and into the space immediately above the last tray.

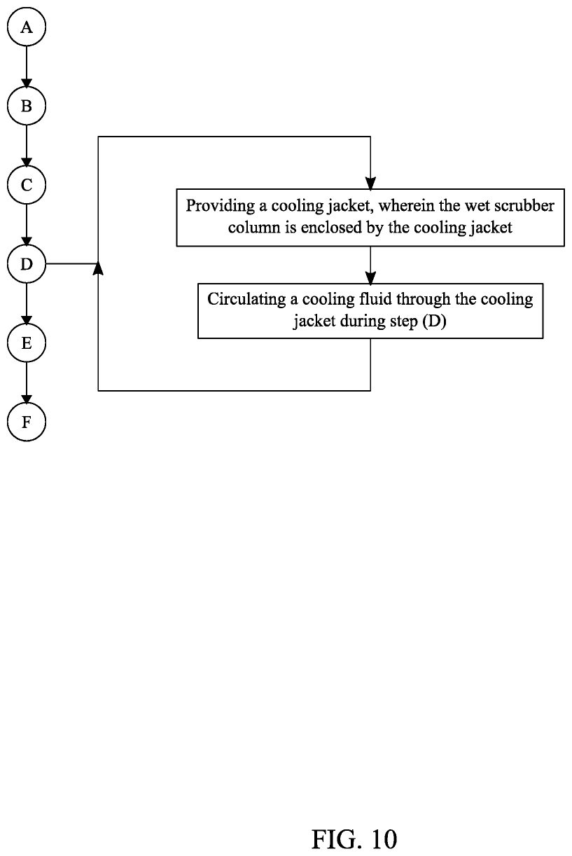

As can be seen in FIGS. 1 and 10, another specification that may be made to the overall process is to lower the temperature of the wet scrubber column 1 with a cooling jacket 10 so that the wet scrubber column 1 is enclosed by the cooling jacket 10. The cooling jacket 10 improves the separation performance of exchanging isotopologues from a gas stream to an aqueous liquid. Thus, a cooling fluid is circulated through the cooling jacket 10 during Step D. This allows, at a lower temperature, water vapor to condense so that the equilibrium isotope separation factor between liquid and vapor is more favorable for heavier isotopes to concentrate in the liquid phase. The cooling fluid is preferably water at a temperature range between 4 degrees Celsius and 10 degrees Celsius.

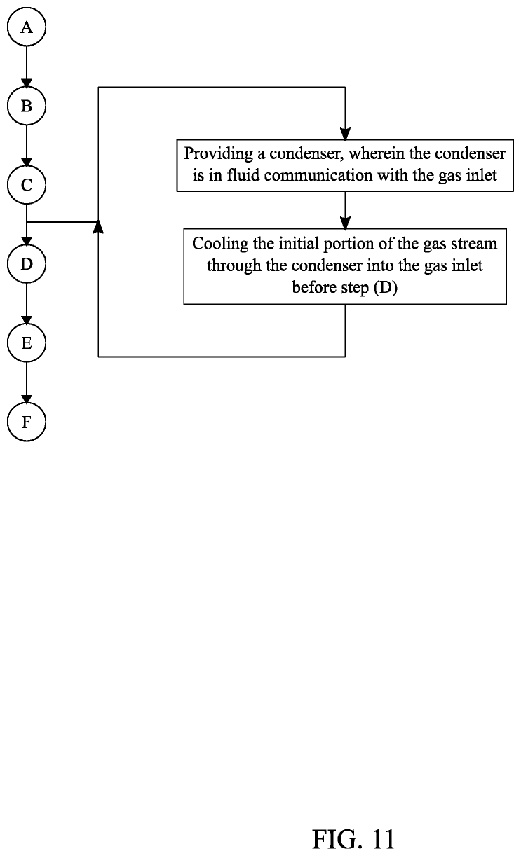

As an alternative to the cooling jacket 10, another specification that may be made to the overall process is to lower the temperature of the initial portion of the gas stream prior to entering the wet scrubber column 1, which is shown in FIGS. 2 and 11. A condenser 11 is provided to lower the temperature of the initial portion of the gas stream and is in fluid communication with the gas inlet 4. Thus, the initial portion of gas stream is cooled as the initial portion of gas stream flows through the condenser 11 and into the gas inlet 4 before Step D. This provides the same benefits as the cooling jacket 10 without having to cool the entire volume of the wet scrubber column 1. Moreover, the initial quantity of aqueous liquid does not require pre-cooling in the same way that the initial portion of the gas stream should be pre-cooled because the flowrate of the initial quantity of aqueous liquid is relatively small in comparison to the flowrate of the initial portion of the gas stream. Consequently, the temperature of the initial quantity of aqueous liquid has a relatively small effect on the operating temperature of the wet scrubber column 1.

Another specification that may be made to the overall process is the arrangement of the gas inlet 4 and the gas outlet 5 allowing the initial portion of the gas stream to continuously flow through the wet scrubber column 1 and the arrangement of the liquid inlet 2 and the liquid outlet 3 allowing the initial quantity of aqueous liquid to continuously flow through the wet scrubber column 1. This specification also requires that the wet scrubber column 1 is positioned in a vertical manner. Thus, the gas outlet 5 is positioned at a highest gravitational point of the wet scrubber column 1 because a gas portion of a gas-and-liquid mixture retained within a vertically-oriented enclosure rises to the top of the vertically-oriented enclosure. Moreover, the liquid inlet 2 is positioned adjacent to the highest gravitational point of the wet scrubber column 1 so that the initial quantity of aqueous liquid is able to countercurrently contact the initial portion of the gas stream for the maximum allowable distance along the wet scrubber column 1 without interfering with the exit of the initial portion of the gas stream through the gas outlet 5. Similarly, the liquid outlet 3 is positioned at a lowest gravitational point of the wet scrubber column 1 because a liquid portion of a gas-and-liquid mixture retained within a vertically-oriented enclosure flows to the bottom of the vertically-oriented enclosure. In addition, the gas inlet 4 is positioned adjacent to a lowest gravitational point of the wet scrubber column 1 so that the initial portion of the gas stream is able to countercurrently contact the initial quantity of the aqueous liquid for the maximum allowable distance along the wet scrubber column 1 without interfering with the exit of the initial quantity of aqueous liquid through the liquid outlet 3.

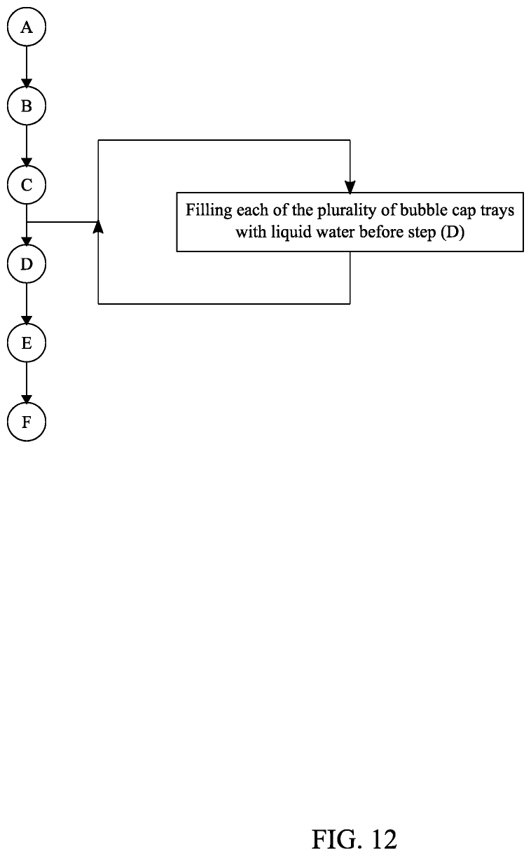

As can be seen in FIG. 12, the wet scrubber column 1 may be dry from a shutdown state prior to the overall process. Thus, each of the plurality of bubble cap trays 6 is filled with liquid water before Step D, which places the wet scrubber column 1 into a standby state that allows the wet scrubber column 1 to be ready to restart the overall process. This liquid water is preferably clean of isotopologues.

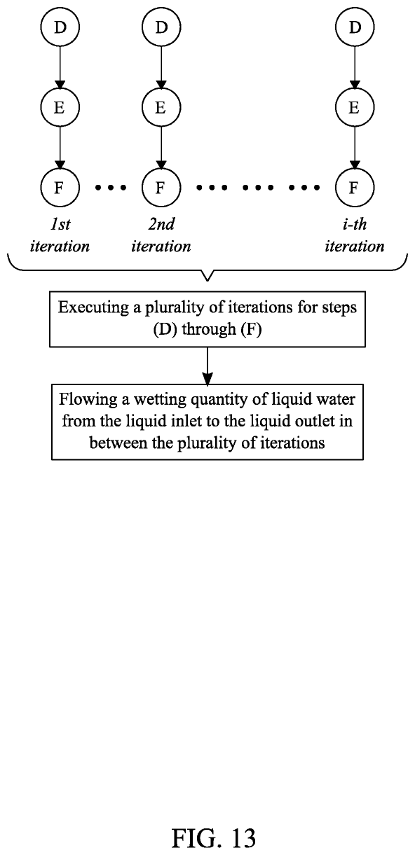

As can be seen in FIG. 13, the wet scrubber column 1 may be configured to execute a plurality of iterations for Steps D through F. In order to maintain the wet scrubber column 1 in a standby state, a wetting quantity of liquid water flows from the liquid inlet 2 to the liquid outlet 3 in between the plurality of iterations. Thus, each of the plurality of bubble cap trays 6 is already filled with liquid water before the start of the next iteration of Steps D through F, which allows the wet scrubber column 1 to be ready to execute the next iteration of Steps D through F.

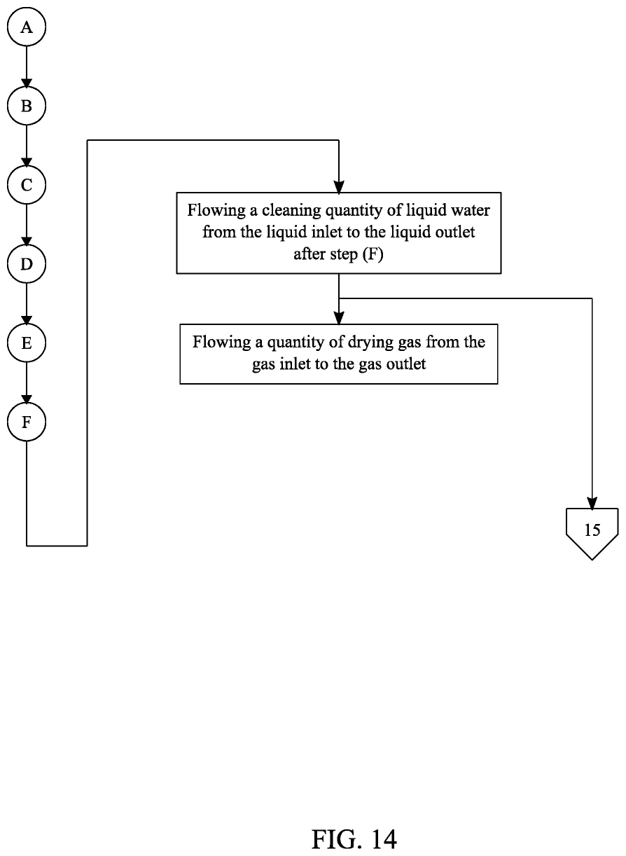

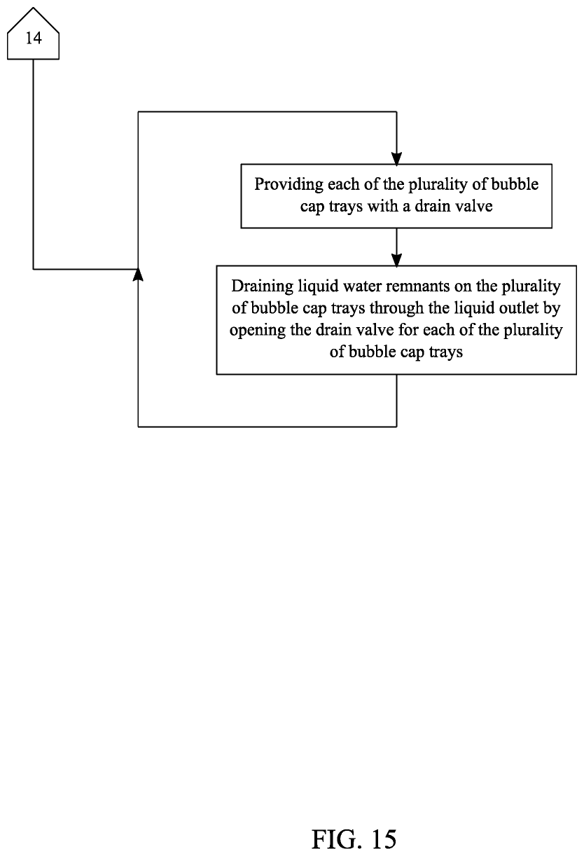

The wet scrubber column 1 may also be placed into a shutdown state, which is shown in FIG. 14. In order to implement the shutdown state, a cleaning quantity of liquid water flows from the liquid inlet 2 to the liquid outlet 3 after Step F. The cleaning quantity of liquid water is used to sufficiently purge the wet scrubber column 1 of isotopologues. After the cleaning quantity of liquid water passes through the wet scrubber column 1, liquid water remnants on the plurality of bubble cap trays 6 need to be drained through the liquid outlet 3, which is shown in FIG. 15. Thus, each of the plurality of bubble cap trays 6 is provided with a drain valve 7, and the drain valve 7 for each of the plurality of bubble cap trays 6 is opened in order to drain the liquid water remnants on the plurality of bubble cap trays 6 through the liquid outlet 3. This allows almost all of the liquid water to be removed from the wet scrubber column 1. Subsequently, a quantity of drying gas flows from the gas inlet 4 to the gas outlet 5. The quantity of drying gas is used to purge any residual moisture within the wet scrubber column 1. The quantity of drying gas can be, but is not limited to, air, nitrogen, or combinations thereof. Once the quantity of drying gas has exited the gas outlet 5, the wet scrubber column 1 is then in the shutdown state.

Although the invention has been explained in relation to its preferred embodiment, it is to be understood that many other possible modifications and variations can be made without departing from the spirit and scope of the invention as hereinafter claimed.

What is claimed is:

1. A method for recovering isotopologues from a gas stream, the method comprises the steps of:
(A) providing a wet scrubber column, wherein the wet scrubber column includes a liquid inlet, a liquid outlet, a gas inlet, a gas outlet, and a plurality of bubble cap trays, and wherein the liquid inlet and the liquid outlet are in fluid communication with each other through the plurality of bubble cap trays, and wherein the gas inlet and the gas outlet are in fluid communication with each other through the bubble cap trays;
(B) providing a gas stream, wherein an initial portion of the gas stream is enriched with isotopologues;
(C) providing an initial quantity of aqueous liquid, wherein the initial quantity of aqueous liquid is depleted of isotopologues;
(D) countercurrently contacting the initial portion of the gas stream with the initial quantity of aqueous liquid through the plurality of bubble cap trays as the initial portion of the gas stream traverses from the gas inlet to the gas outlet and as the initial quantity of aqueous liquid traverses from the liquid inlet to the liquid outlet;
(E) capturing a processed portion of the gas stream from the gas outlet, wherein the processed portion of the gas stream is depleted of isotopologues; and
(F) capturing a processed quantity of aqueous liquid from the liquid outlet, wherein the processed quantity of aqueous liquid is enriched with isotopologues.

2. The method for recovering isotopologues from a gas stream, the method as claimed in claim 1, wherein the gas stream is made of an incondensable gas.

3. The method for recovering isotopologues from a gas stream, the method as claimed in claim 1, wherein the initial quantity of aqueous liquid continuously flows from the liquid inlet to the liquid outlet during step (D).

4. The method for recovering isotopologues from a gas stream, the method as claimed in claim 3, wherein the wet scrubber column further includes a plurality of downcomers, and wherein each adjacent pair of trays from the plurality of bubble cap trays is in fluid communication with each other through a corresponding downcomer from the plurality of downcomers, and wherein the initial quantity of aqueous liquid continuously flows through the plurality of bubble cap trays by the plurality of downcomers during step (D).

5. The method for recovering isotopologues from a gas stream, the method as claimed in claim 3, wherein the initial quantity of aqueous liquid continuously flows from the liquid inlet to the liquid outlet during step (D) at a static liquid flowrate.

6. The method for recovering isotopologues from a gas stream, the method as claimed in claim 3, wherein the initial quantity of aqueous liquid continuously flows from the liquid inlet to the liquid outlet during step (D) at a dynamic liquid flowrate, and wherein the dynamic liquid flowrate is adjusted to maintain a constant liquid-to-gas flow ratio.

7. The method for recovering isotopologues from a gas stream, the method as claimed in claim 1 comprises the steps of:
providing a continuous liquid flow, wherein the continuous liquid flow is the initial quantity of aqueous liquid flowing from the liquid inlet, through the plurality of bubble cap trays, and to the liquid outlet during step (D); and
liquid-sealing a serial transference of the initial portion of the gas stream through the plurality of bubble cap trays with the continuous liquid flow.

8. The method for recovering isotopologues from a gas stream, the method as claimed in claim 7 comprises the steps of:
providing the wet scrubber column with a sump, wherein a last tray and the liquid outlet are in fluid communication with each other through the sump, and wherein the last tray is from the plurality of bubble cap trays, and wherein the continuous liquid flow is the initial quantity of aqueous liquid flowing from the liquid inlet, through the plurality of bubble cap trays, through the sump, and to the liquid outlet during step (D); and
further liquid-sealing the initial portion of the gas stream between the last tray and the sump with the continuous liquid flow.

9. The method for recovering isotopologues from a gas stream, the method as claimed in claim 1 comprises the steps of:
providing a cooling jacket, wherein the wet scrubber column is enclosed by the cooling jacket; and
circulating a cooling fluid through the cooling jacket during step (D).

10. The method for recovering isotopologues from a gas stream, the method as claimed in claim 9, wherein the cooling fluid is water at a temperature range between 4 degrees Celsius and 10 degrees Celsius.

11. The method for recovering isotopologues from a gas stream, the method as claimed in claim 1 comprises the steps of:
providing a condenser, wherein the condenser is in fluid communication with the gas inlet; and
cooling the initial portion of the gas stream through the condenser into the gas inlet before step (D).

12. The method for recovering isotopologues from a gas stream, the method as claimed in claim 1, wherein the gas inlet is positioned adjacent to a lowest gravitational point of the wet scrubber column.

13. The method for recovering isotopologues from a gas stream, the method as claimed in claim 1, wherein the gas outlet is positioned at a highest gravitational point of the wet scrubber column.

14. The method for recovering isotopologues from a gas stream, the method as claimed in claim 1, wherein the liquid inlet is positioned adjacent to a highest gravitational point of the wet scrubber column.

15. The method for recovering isotopologues from a gas stream, the method as claimed in claim 1, wherein the liquid outlet is positioned at a lowest gravitational point of the wet scrubber column.

16. The method for recovering isotopologues from a gas stream, the method as claimed in claim 1 comprises the step of:
filling each of the plurality of bubble cap trays with liquid water before step (D).

17. The method for recovering isotopologues from a gas stream, the method as claimed in claim 1 comprises the steps of:
executing a plurality of iterations for steps (D) through (F); and
flowing a wetting quantity of liquid water from the liquid inlet to the liquid outlet in between the plurality of iterations.

18. The method for recovering isotopologues from a gas stream, the method as claimed in claim 1 comprises the steps of:
flowing a cleaning quantity of liquid water from the liquid inlet to the liquid outlet after step (F); and
flowing a quantity of drying gas from the gas inlet to the gas outlet.

19. The method for recovering isotopologues from a gas stream, the method as claimed in claim 18 comprises the steps of:
providing each of the plurality of bubble cap trays with a drain valve; and
draining liquid water remnants on the plurality of bubble cap trays through the liquid outlet by opening the drain valve for each of the plurality of bubble cap trays.

20. The method for recovering isotopologues from a gas stream, the method as claimed in claim 18, wherein the quantity of drying gas is selected from a group consisting of: air, nitrogen, and combinations thereof.
